(19) United States
(12) Patent Application Publication
(10) Pub. No.: US 2026/0330461 A1
(43) Pub. Date: Oct. 22, 2026

(54) ORGANIZATION SPECIFIC ANALYZERS FOR DETECTING MALICIOUS CONTENT IN A DISTRIBUTED LEDGER NETWORK

(71) Applicant: Dell Products L.P., Round Rock, TX (US)

(72) Inventors: Ahmed Khalid, Cork (IE); Alan Barnett, Co. Cork (IE); Judith A. Furlong, Natick, MA (US)

(21) Appl. No.: 19/184,597

(22) Filed: Apr. 21, 2025

(51) Int. Cl. G06Q 20/40; G06Q 20/38

(52) U.S. Cl. CPC G06Q 20/4016; G06Q 20/3825

(57) ABSTRACT

Securing network nodes of a distributed ledger by detecting undesirable content is disclosed. When a transaction is received from a client, content of the transaction is analyzed for undesirable content by each of the nodes. The nodes may perform customized content analysis that differs from node to node. The nodes, after performing the content analysis, vote on whether to accept the transaction. When the vote is affirmative and as long a voting threshold is satisfied, the transaction is committed to the distributed ledger. Otherwise, the transaction is rejected and not stored in the distributed ledger. When undesirable content is determined, a report is made to an auditor, which is configured to perform an action based on the report.

### TECHNOLOGICAL FIELD OF THE DISCLOSURE

Embodiments disclosed herein generally relate to distributed ledger technologies. More particularly, at least some embodiments relate to systems, hardware, software, computer-readable media, and methods for committing transactions to distributed ledger nodes and more particularly to detecting undesirable content in transactions.

### BACKGROUND

Distributed ledger technologies (DLTs) (e.g., blockchains) are decentralized systems that enable transactions to be recorded across multiple nodes within a distributed ledger network. The ability to immutably store transactions is a significant benefit of DLTs. When committing a transaction to a distributed ledger network, cryptographic techniques are used to create an immutable and chronological chain of transactions (e.g., blocks or graphs). The chain of transactions, and the content within the transactions, is stored on all the nodes in the DLT network. This configuration ensures that no single entity has complete control of the transactions or has the ability to tamper with the content. The distributed and tamper-resistant nature of DLTs enhances transparency, reduces the risk of fraud, and facilitates trust among participants in the distributed ledger network. These characteristics make DLTs suitable for applications such as cryptocurrencies, smart contracts, and supply chain management.

These characteristics can also complicate the ability to resolve security and compliance concerns. For example, much effort has been given to identify security and compliance concerns related to hosting public immutable data in an organization’s network and to devise solutions that can mitigate threats and non-compliance.

For example, security/compliance issues facing organizations that host public immutable data include issues related to undesirable content, such as illegal content. Freely editable fields, for example, are exploited to place illegal content in a DLT. The illegal content often includes the kind of imagery that is illegal in virtually every country but could also include content such as leaked personal identifying information.

Storing or distributing illegal content is a significant problem for DLT services and participants. Nonetheless, multiple prominent DLTs presently have instances of such imagery. There is low impetus regarding removing illegal content even amongst platforms where removal is relatively trivial, such as in social media. Removing illegal content from a DLT typically requires enormous effort due to the immutable nature of the DLT. For example, carrying out a hard fork may resolve the issue, but involves substantial effort.

Other than the effort of removal, the presence of illegal content on a DLT does not functionally impact the day-to-day running of the DLT and until recently, there has not been significant pressure, or consequences imposed by authorities to motivate these platforms to combat the issue.

The implications of illegal content do not stop at the platform or service provider level. When illegal content is placed on a node of a DLT, the illegal content will propagate to other nodes in the DLT, which are under an obligation to run in compliance with the up-to-date network version. The person or entity running the DLT node, as a consequence, is technically in possession of illegal content.

Undesirable content may also pose a potential security vulnerability. For instance, injecting content into the DLT could be used for backdoor patching viruses already deployed or may be leveraged as part of an injection attacked.

Recently, various jurisdictions and collective are placing increased responsibility on DLT platforms and services to combat illegal content on their systems. Examples include the European Union’s Digital Services Act and the United Kingdom’s Online Safety Bill. While social media and file shares are a primary focus of this legislation, DLTs are in an untenable position and need to address these concerns to preserve functionality and maintain compliance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a distributed ledger;

FIG. 2 discloses aspects of committing a transaction to a distributed ledger;

FIG. 3 discloses aspects of detecting undesirable content and preventing undesirable content from being stored in a distributed ledger; and

FIG. 4 discloses aspects of a computing device, system, or entity.

### DETAILED DESCRIPTION OF SOME EXAMPLE EMBODIMENTS

Embodiments disclosed herein generally relate to distributed ledger technologies (DLTs). More particularly, at least some embodiments relate to systems, hardware, software, computer-readable media, and methods for detecting undesirable content in distributed ledgers and preventing undesirable content from being committed to distributed ledgers. Embodiments of the invention further relate to node specific content analysis in the context of accepting and/or rejection transactions in DLTs.

Embodiments of the invention relate to DLTs, such as blockchains, where autonomous decentralized nodes work together to create replicas of an immutable ledger. Embodiments of the invention may be implemented in various DLT platforms or services and can be adapted to the details (e.g., protocols, architectures) of specific DLTs. Hedera, Bitcoin, Ethereum, and Hyperledger are examples of DLTs in which embodiments of the invention may be implemented. DLTs and the like are referred to herein as distributed ledgers by way of example.

Embodiments of the invention are discussed in the context of a distributed ledger and transactions that are stored or committed to the distributed ledger. Distributed ledgers may be public, private, permissioned, permissionless, or the like. A distributed ledger may include nodes (e.g., servers, clusters with processors and memory) and the nodes may be implemented in the cloud, at the edge, on-premise, or the like or combinations thereof.

By way of example, a distributed ledger may be associated with transactions and messages. A transaction may relate to changes in the ledger. Example transactions may relate to digital assets, digital currency, asset transfer, recording data, smart contracts, or the like or combinations thereof. Generally, valid transactions are committed to the distributed ledger. Messages, in contrast, may be used to convey information and messages may or may not be committed to the distributed ledger. For example, messages may be used for status updates, commands, voting, protocols, node communications, or the like or combinations thereof. Embodiments of the invention focus on transactions that are changes to the distributed ledger and are immutably stored therein.

In some examples, each node of a distributed ledger may be configured to conduct content analysis. However, different nodes may have different perceptions of what qualifies as undesirable content. Designating content as undesirable content may be influenced by location, local regulations, and the like. Thus, content that is acceptable from the perspective of one node may be undesirable from the perspective of another node. Embodiments of the invention provide nodes with flexibility to make their own determinations based on their specific circumstances and requirements.

Embodiments of the invention may provide or include application programming interfaces (APIs) that can be used by the nodes when making a decision as to whether or not to accept a transaction. Content of a transaction can be passed to analyzers (e.g., content analyzers, compliance analyzers) using these APIs.

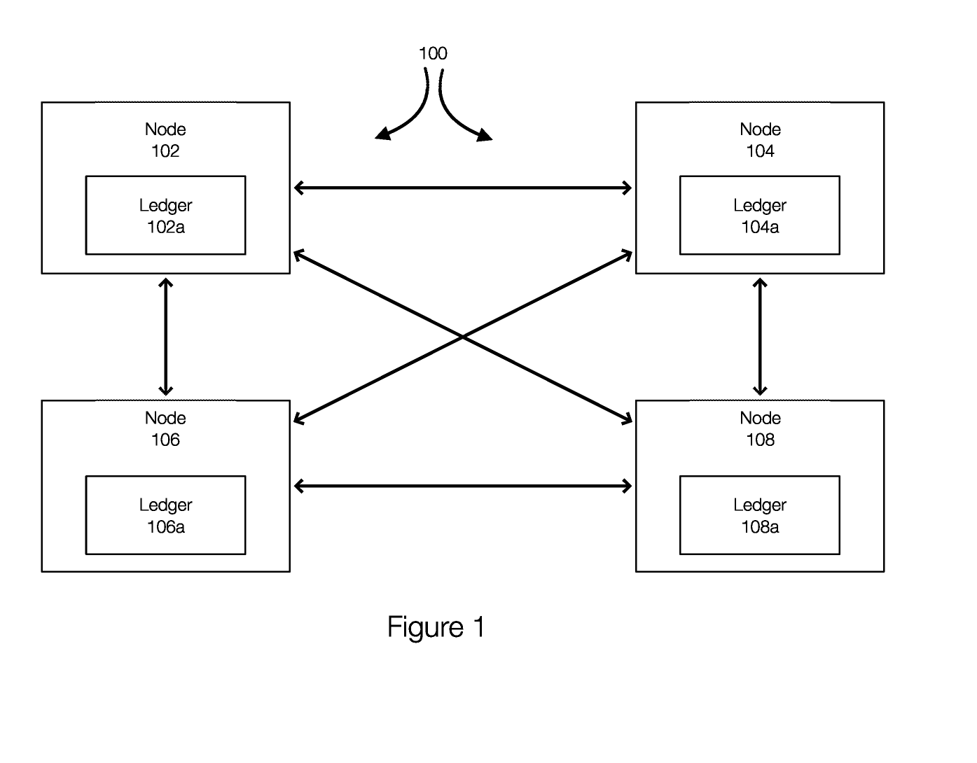

FIG. 1 discloses aspects of an example distributed ledger. A distributed ledger 100 includes nodes, represented as nodes 102, 104, 106, and 108. The nodes 102, 104, 106, and 108 may be associated with different operators, in different geographical locations, connected to different networks, and the like. The distributed ledger 100 is implemented by creating a replica or copy of the ledger at each of the nodes. Thus, the distributed ledger 100 is stored at or accessible by the nodes 102, 104, 106, and 108 and the nodes 102, 104, 106, and 108 are able to communicate with one another.

In this example of the distributed ledger 100, the node 102 stores and runs a copy or replica of the ledger, illustrated as the ledger 102a. The copies or replicas of the distributed ledger stored and run by the nodes 104, 106, and 108 are represented as, respectively, ledgers 104a, 106a, and 108a. The ledgers 102a, 104a, 106a, and 108a may be implemented in non-transitory memory or storage devices.

In this example of the distributed ledger 100, the network nodes 102, 104, 106, and 108 are required to store all the transactions that are received by the distributed ledger 100 to their internal storage – the ledgers 102a, 104a, 106a, and 108a. This may lead to potential legal or technical challenges if content in the transactions is or includes undesirable content (e.g., malicious content, illegal content, non-compliant content).

In one example, network nodes 102, 104, 106, and 108 receive transactions from clients. For example, the distributed network 100 may be used to store digital wallets, each associated with a different client. A client may desire to transfer an asset to another client or elsewhere and this is achieved by sending a transaction to the distributed ledger 100.

The nodes 102, 104, 106, and 108 validate the transactions and execute a consensus mechanism for each of the transactions. Once a consensus is reached among the nodes 102, 104, 106, and 108 with respect to a particular transaction, each node adds that particular transaction and the associated content to its corresponding replica or copy of the distributed ledger using, in one example, cryptographic techniques. Thus, the node 102 adds the validated transaction to the ledger 102a, the node 104 adds the validated transaction to the ledger 104a, the node 106 adds the validated transaction to the ledger 106a, and the node 108 adds the validated transaction to the node 108a. This creates replicas of an immutable transaction log across all the network nodes 102, 104, 106, and 108.

In this example, transactions, but not messages, are committed to the distributed ledger. In other examples, transactions and messages are committed to the distributed ledger. More generally, different DLTs may have different protocols and terminology. This example assumes that at least transactions are committed to the distributed ledger 100.

Further, a transaction may be received at one node (e.g., the node 102) or at multiple nodes (e.g., at the nodes 102 and 104). The distributed ledger 100 may have a mechanism or protocol to forward or share the transaction with the other nodes in the distributed ledger 100. This ensures that the ledgers 102a, 104a, 106a, and 108a are kept up to date and consistent over time as transactions are validated and reviewed for undesirable content.

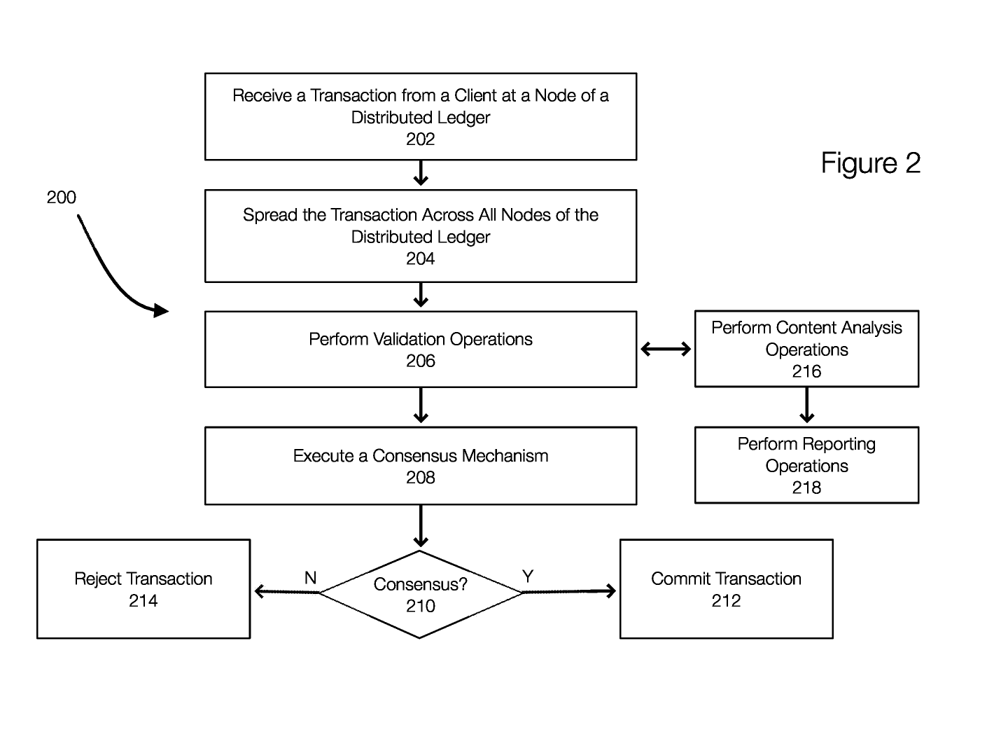

FIG. 2 discloses aspects of persisting a transaction to a distributed ledger. The method 200 may include receiving 202 a transaction from a client (e.g., a sender) at a node (or multiple nodes) of a distributed ledger. The node or nodes receiving the transaction may perform a protocol (e.g., a broadcast or gossip protocol) to spread 204 the transaction across all nodes of the distributed ledger.

In one example, each of the nodes may perform 206 validation operations. In some examples, specific nodes may be identified as consensus nodes may be tasked with determining whether to accept or reject a transaction in the distributed ledger. In this example, validation operations are performed 206 by all nodes in the distributed ledger.

In one example, the validation operations may include verifying the digital signatures of the client (e.g., the sender), ensuring that the transaction follows an acceptable format, and confirming that the sender has sufficient funds. In one example, the validation operations may include content analysis operations.

Performing 206 the validation operations may also include performing 216 content analysis operations. In this example, the content analysis operations may be accessed using APIs. Using APIs allows each node to perform their own content analysis, which may be different from the content analysis performed at other nodes. Thus, The content analysis operations performed by each node may include organization specific or node specific content analysis operations.

In one example, an organization may require transactions to include a certain value in a particular field, which may not be required by other organizations hosting a node of the distributed ledger. Thus, the content analysis operations performed by that node may include a check to determine whether that particular field contains a valid value or entry. This may result in a situation where one node votes against the transaction (reject) due to a specific compliance requirement while another node may vote to accept the transaction.

If the transaction is validated by the nodes (or the consensus nodes or sufficient portion thereof) and the content analysis determines that the transaction or its content is acceptable, a consensus mechanism may be executed 208.

The consensus mechanism may take a variety of forms. In one example, each node casts a virtual vote on whether the content is acceptable or whether the content should be rejected. Thus, a node may vote accept or reject in one example. The votes may be counted and where a sufficient number of accept votes are cast, consensus (Y at 210) is achieved and the transaction is committed 212 to the distributed ledger by the nodes. If the transaction does not received enough accept votes, the voting does not reach the required threshold (N at 210), the transaction is rejected 214 and not stored in the distributed ledger.

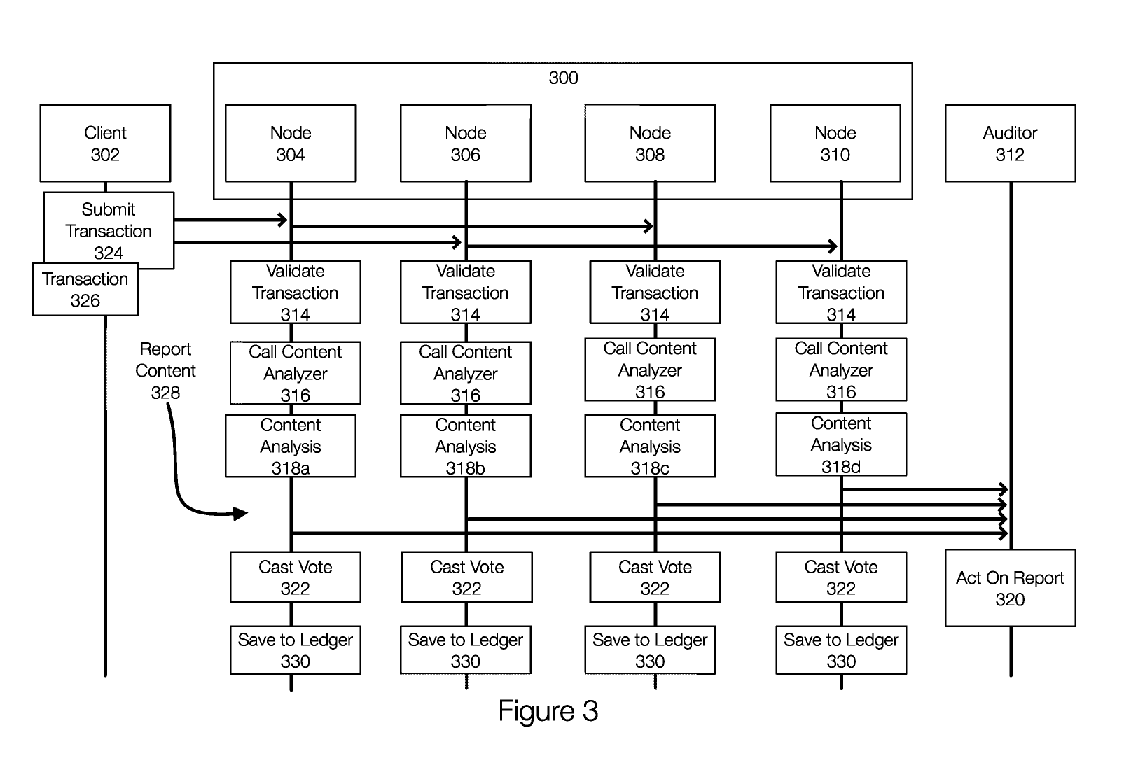

FIG. 3 discloses additional aspects of detecting undesirable content and preventing undesirable content from being stored at the replica ledgers maintained by nodes participating in a distributed ledger.

FIG. 3 illustrates a distributed ledger 300 that includes nodes 304, 306, 308, and 310. In this example, a client 302 submits 324 a transaction 326 to nodes 304 and 306. Thus, the transaction 326 is received at nodes 304 and 306 of the distributed ledger 300. The transaction is then spread by the receiving nodes to the other nodes in the distributed ledger 300. In this example, the node 304 spreads the transaction 326 to the node 308 and the node 306 spreads the transaction 326 to the node 310.

Next, the nodes 304, 306, 308, and 310 validate 314 the transaction. In one example, the validation 314 is substantially the same at each of the nodes 304, 306, 308, and 310. This may include verifying signatures, verifying a format of the transaction (or message), ensuring that the client 302 has a sufficient balance, or the like.

Next, the nodes 304, 306, 308, and 310 call 316 their respective content analysis functions (e.g., 318a-318d) using respective APIs. More specifically, in this example, the node 304 is associated with a content analysis 318a, the node 306 is associated with a content analysis 318b, the node 308 is associated with a content analysis 318c, and the node 310 is associated with a content analysis 318d. The content analysis 318a is specific to the requirements of the node 304. Similarly the content analysis 318b, 318c, and 318d are specific to the requirements of, respectively, the nodes 306, 308, and 310.

The content of the transaction 326 is analyzed by each of the nodes 304, 306, 308, and 310 using, respectively, the content analysis 318a, 318b, 318c, and 318d. The content analysis performed by each the content analysis 318a-318d may be performed independently and separately. This helps protect the distributed ledger 300 from compromised nodes.

Content analysis operations may include, but are not limited to, detecting malicious elements (e.g., malware), anomalies, fraudulent behavior, keywords as defined by a provider of the distributed ledger, illegal images, or the like or combinations thereof. The content of the transaction 326 can be analyzed using various rules, machine learning (e.g., a model trained on valid and/or undesirable content), or the like.

The ability of the node 304 to call 316 a content analysis 318a adds a dynamic aspect to the content analysis operations and allows each node to perform its own content analysis. In addition, the consensus protocol is unaffected and can be deployed or upgraded on existing or new nodes of the distributed ledger 300, while providing organizations (or node operators) with the flexibility of applying their own specific content analysis.

The transaction 326 may include, by way of example only, free-form text fields that could be exploited to insert undesirable content. Thus, the content analysis 318a can evaluate or analyze the content in accordance with requirements of the node 304. Content may also be added in unused portions of existing fields.

The nodes 304, 306, 308, and 310 may or may not report 328 undesirable content to an auditor 312. For example, the transaction 326 may be reported only when undesirable content is detected. The auditor 312 may be an external auditor, a regulatory body, a compliance team, and/or the like. The report may include an identify of the client 302, a reason for submitting the report or flagging the transaction 326, the undesirable content, or the like.

Because the content analysis 318a, 318b, 318c, and 318d are different in some examples, undesirable content may be reported by only some of the nodes. Further, a response of the content analysis 318a-318d, via the API, may be a Boolean value indicating whether the transaction should be accepted or rejected.

The auditor 312 may act 320 on the report. If the auditor 312 is sufficiently associated with the distributed ledger 300, the auditor 312 may, of its own accord, reject the transaction. Alternatively, the auditor 312 may notify a relevant authority. This may be performed automatically. For example, if the node 304 issues a report that the transaction 326 includes illegal content, the auditor 312 may act 320 only with respect to the jurisdiction or regulatory authority associated with the node 304 at least because the content was not reported as illegal by the other nodes in this example.

In another example, after reporting 328 the content (or not reporting the content 328), the consensus mechanism is executed. In this example, the nodes 304, 306, 308, and 310 cast votes 322 (e.g., virtual votes). Each vote may vote to accept the transaction or reject the transaction. Casting votes 322 determines whether the transaction 326 is saved 330 to the ledger (e.g., the node commits the transaction 326 to their respective replicas or copies of the distributed ledger).

In one example, consensus is achieved when accept or yes votes achieve a required voting threshold level (e.g., above 50%, above 66%), which voting threshold level may be determined by the distributed ledger.

In one example, the content analysis 318a-d ensures that each of the nodes 304, 306, 308, and 310 are involved in the process of deciding whether to accept the transaction 326 based on their own considerations and requirements. More specifically, each of the nodes 304, 306, 308, and 310 can determine independently of the other nodes whether the transaction 326 includes undesirable content.

In one example, the distributed ledger 300 may introduce various rules that may impact voting. For example, nodes that can a reject vote may be weighted based on the reason for flagging the transaction. Further, the distributed ledger 3000 may be configured to reject a transaction in certain circumstances (e.g., the content is illegal with respect to a single node). In this example, votes may include a content type to aid in counting the votes.

Advantageously, embodiments of the invention ensure that undesirable content is rejected even if one or more entry points (nodes that that received the transaction from the client 302) are compromised. Undesirable content is saved to the distributed ledger only if the required threshold of nodes are compromised. Advantageously, accurate content rejection and reporting is as reliable as the distributed ledger itself. Embodiments of the invention prevent undesirable content from being stored in the distributed ledger 300, which removes the complicated process of removing undesirable content from an immutable distributed ledger.

As a result, content that is marked or voted as valid or safe (e.g., both validation and content analysis pass) by the required threshold of votes is persisted in the distributed ledger while content that does not receive the required votes is discarded and not written to the distributed ledger.

Embodiments of the invention validate transactions in a manner that includes customized content analysis from the node’s perspectives. Analyzing the content of a transaction allows undesirable content, such as malicious content, unethical content, non-compliant data, and the like, which may be stored in or included in the transaction (e.g., in free-form text fields) to be identified and rejected. Further, embodiments of the invention involve all (or a threshold number) of nodes in the content analysis to protect against compromised nodes. Embodiments of the invention further ensure that malicious clients (senders) and/or their content is detected and reported.

Content determined to be undesirable is not written to the distributed ledger. Embodiments of the invention proactively and advantageously prevent undesirable content from being written to the distributed ledger. This is an improved outcome compared to removing undesirable content that has already been committed to the distributed ledger. Removing existing undesirable content is substantially more difficult (may require a hard fork) due to the immutable nature of the distributed ledger.

In one example, application programming interfaces (APIs) are provided that allow a node to pass the content of a transaction to content analyzer functions. This allows a variety of different functions to be implemented, adjusted, added, revised, and the like in order to detect undesirable content in a dynamic and changeable manner.

In one example, the ability to customize the content analysis may prevent consensus such that undesirable content is rejected.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, distributed ledger operations, validation operations, content analysis operations, auditing operations, reporting operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software.

Example embodiments are applicable to any system capable of storing and handling various types of objects or data, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: validating, by nodes of a distributed ledger, a transaction received into the distributed ledger, performing, by each of the nodes: calling an application programming interface to access content analysis functions, performing a content analysis on content included in the transaction on the transaction using the content analysis functions, determining whether the transaction includes undesirable content independently of the other nodes in the distributed ledger by the content analysis functions, and casting a vote based on a result of the content analysis to accept the transaction into the distributed ledger or a vote to reject the transaction without storing the transaction in the distributed ledger, and committing the transaction to the distributed ledger, by the nodes, when votes from the nodes to accept the transaction exceed a threshold voting requirement, wherein the content analysis is different for at least some of the nodes.

Embodiment 2. The method of embodiment 1, further comprising: receiving the transaction at one or more of the nodes in the distributed ledger, wherein the transaction is received from a client, and spreading the transaction to all of the nodes in the distributed ledger.

Embodiment 3. The method of embodiment 1 and/or 2, wherein the validating the transaction includes verifying a signature of the client, verifying a format of the transaction, and/or verifying that the client has a sufficient balance for the transaction.

Embodiment 4. The method of embodiment 1, 2, and/or 3, wherein the undesirable content includes malicious content, anomalous content, content related to or indicative of fraudulent behavior, keywords defined by a provider of the distributed ledger, malware, and/or illegal content including illegal images.

Embodiment 5. The method of 1, 2, 3, and/or 4, wherein the content analysis performed by a particular node is based on content and/or compliance requirements of that particular node.

Embodiment 6. The method of 1, 2, 3, 4, and/or 5, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

Embodiment 7. The method of 1, 2, 3, 4, 5, and/or 6, wherein the report comprises an identity of the sender and a reason for flagging the undesirable content.

Embodiment 8. The method of 1, 2, 3, 4, 5, 6, and/or 7, wherein the threshold voting requirement is a majority or a supermajority.

Embodiment 9. The method of 1, 2, 3, 4, 5, 6, 7, and/or 8, wherein performing the content analysis by all of the nodes is configured to protect the distributed ledger from compromised nodes.

Embodiment 10. The method of 1, 2, 3, 4, 5, 6, 7, 8, and/or 9, wherein the content analysis, when the content includes the undesirable content, is prevented from being committed to the distributed ledger.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments or edge environment where one or more of a client, server, or other machine may reside and operate in a cloud environment or edge environment.

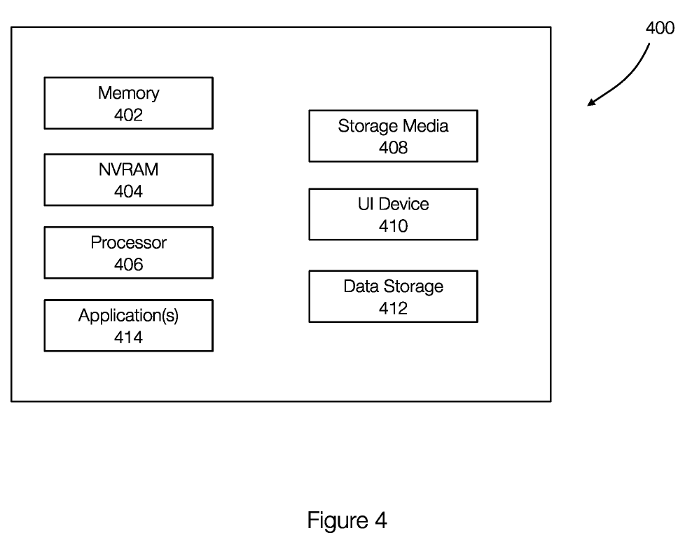

With reference briefly now to FIG. 4, any one or more of the entities disclosed, or implied, by Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method comprising:
validating, by nodes of a distributed ledger, a transaction received into the distributed ledger;
performing, by each of the nodes:
calling an application programming interface to access content analysis functions;
performing a content analysis on content included in the transaction on the transaction using the content analysis functions;
determining whether the transaction includes undesirable content independently of the other nodes in the distributed ledger by the content analysis functions; and
casting a vote based on a result of the content analysis to accept the transaction into the distributed ledger or a vote to reject the transaction without storing the transaction in the distributed ledger; and
committing the transaction to the distributed ledger, by the nodes, when votes from the nodes to accept the transaction exceed a threshold voting requirement,
wherein the content analysis is different for at least some of the nodes.

2. The method of claim 1, further comprising:
receiving the transaction at one or more of the nodes in the distributed ledger, wherein the transaction is received from a client; and
spreading the transaction to all of the nodes in the distributed ledger.

3. The method of claim 2, wherein the validating the transaction includes verifying a signature of the client, verifying a format of the transaction, and/or verifying that the client has a sufficient balance for the transaction.

4. The method of claim 1, wherein the undesirable content includes malicious content, anomalous content, content related to or indicative of fraudulent behavior, keywords defined by a provider of the distributed ledger, malware, and/or illegal content including illegal images.

5. The method of claim 4, wherein the content analysis performed by a particular node is based on content and/or compliance requirements of that particular node.

6. The method of claim 1, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

7. The method of claim 6, wherein the report comprises an identity of the sender and a reason for flagging the undesirable content.

8. The method of claim 1, wherein the threshold voting requirement is a majority or a supermajority.

9. The method claim 1, wherein performing the content analysis by all of the nodes is configured to protect the distributed ledger from compromised nodes.

10. The method of claim 1, wherein the content analysis, when the content includes the undesirable content, is prevented from being committed to the distributed ledger.

11. A non-transitory storage medium having stored therein instructions that are executable by one or more hardware processors to perform operations comprising:
validating, by nodes of a distributed ledger, a transaction received into the distributed ledger;
performing, by each of the nodes:
calling an application programming interface to access content analysis functions;
performing a content analysis on content included in the transaction on the transaction using the content analysis functions;
determining whether the transaction includes undesirable content independently of the other nodes in the distributed ledger by the content analysis functions; and
casting a vote based on a result of the content analysis to accept the transaction into the distributed ledger or a vote to reject the transaction without storing the transaction in the distributed ledger; and
committing the transaction to the distributed ledger, by the nodes, when votes from the nodes to accept the transaction exceed a threshold voting requirement,
wherein the content analysis is different for at least some of the nodes.

12. The non-transitory storage medium of claim 11, further comprising:
receiving the transaction at one or more of the nodes in the distributed ledger, wherein the transaction is received from a client; and
spreading the transaction to all of the nodes in the distributed ledger.

13. The non-transitory storage medium of claim 12, wherein the validating the transaction includes verifying a signature of the client, verifying a format of the transaction, and/or verifying that the client has a sufficient balance for the transaction.

14. The non-transitory storage medium of claim 11, wherein the undesirable content includes malicious content, anomalous content, content related to or indicative of fraudulent behavior, keywords defined by a provider of the distributed ledger, malware, and/or illegal content including illegal images.

15. The non-transitory storage medium of claim 14, wherein the content analysis performed by a particular node is based on content and/or compliance requirements of that particular node.

16. The non-transitory storage medium of claim 11, further comprising reporting the transaction to an auditor by the nodes that determine that the transaction includes the undesirable content, wherein the auditor is an external auditor, a regulatory body, or a compliance entity and is configured to act with respect to the nodes that reported the transaction.

17. The non-transitory storage medium of claim 16, wherein the report comprises an identity of the sender and a reason for flagging the undesirable content.

18. The non-transitory storage medium of claim 11, wherein the threshold voting requirement is a majority or a supermajority.

19. The non-transitory storage medium claim 11, wherein performing the content analysis by all of the nodes is configured to protect the distributed ledger from compromised nodes.

20. The non-transitory storage medium of claim 11, wherein the content analysis, when the content includes the undesirable content, is prevented from being committed to the distributed ledger.
